(19) United States
(12) Patent Application Publication
(10) Pub. No.: US 2019/0176530 A1
(43) Pub. Date: Jun. 13, 2019

(54) PNEUMATIC TIRE

(71) Applicant: Toyo Tire & Rubber Co., Ltd., Itami-shi (JP)

(72) Inventor: Toshikazu Yasunaga, Itami-shi (JP)

(73) Assignee: Toyo Tire & Rubber Co., Ltd., Itami-shi (JP)

(21) Appl. No.: 16/210,441

(22) Filed: Dec. 5, 2018

(30) Foreign Application Priority Data
Dec. 13, 2017 (JP) 2017-238872

(51) Int. Cl. B60C 11/03; B60C 11/12

(52) U.S. Cl. CPC B60C 11/0309; B60C 11/1204; B60C 2011/0346; B60C 2011/0381; B60C 2011/0388; B60C 2011/0372; B60C 2011/0351; B60C 2011/0355; B60C 2011/0367; B60C 2011/0362; B60C 2011/1213

(57) ABSTRACT

A pneumatic tire includes a center land portion (30), a mediate land portion (35), a shoulder land portion (40), and shallow grooves (33, 38, and 43) on a surface of each of the land portions (30, 35, and 40), in which the shallow grooves (33 and 43) in the center land portion (30) and the shoulder land portion (40) have many components in a circumferential direction of the tire, and the shallow grooves (38) in the mediate land portion (35) have more components in a tire width direction than the shallow grooves (33 and 43) in the center land portion (30) and the shoulder land portion (40).

### CROSS-REFERENCE TO RELATED APPLICATIONS

This application is based on Japanese Patent Application No. 2017-238872 (filed on Dec. 13, 2017) and claims priority from Japanese Patent Application No. 2017-238872. The present disclosure incorporates entire contents of Japanese Patent Application No. 2017-238872.

### TECHNICAL FIELD

The present disclosure relates to a pneumatic tire.

### BACKGROUND ART

A surface of a new pneumatic tire is a mirror surface, and a release agent applied to a mold used for molding penetrates into the surface of the new pneumatic tire. Therefore, in some cases, the new pneumatic tire may not be able to exhibit sufficient traveling performance. Attempts have been made to provide shallow grooves on a surface of a tread of a pneumatic tire, and to secure traveling performance for the new pneumatic tire by an edge effect of the shallow grooves.

Patent Document 1 discloses providing a uniform shallow groove over an entire surface of a tread. Patent Document 2 discloses directing an extending direction of a shallow groove which becomes shallower gradually toward a grounding end side (an outer side of a tire width direction) to the tire width direction. Patent Document 3 discloses, in a narrow range in a tread width direction, directing a direction of shallow groove to a circumferential direction of a tire more than other grooves in other locations. Patent Document 4 and Patent Document 5 disclose an annular shallow groove.

Patent Document 1: Japanese Patent No. 3702958

Patent Document 2: Japanese Patent No. 4735137

Patent Document 3: Japanese Patent No. 4519141

Patent Document 4: Chinese Patent Application Publication No. 1789024

Patent Document 5: Europe Patent Application Publication No. 1580034

### DISCLOSURE OF THE INVENTION

### Problem that the Invention is to Solve

By the way, the shallow groove exerts an edge effect in a direction orthogonal to an extending direction thereof. Therefore, when the uniform shallow groove is provided over the entire surface of the tread as in Patent Document 1, balance of a direction of the edge effect is poor. Further, when the extending direction of the shallow groove which becomes shallower gradually toward the grounding end side as in Patent Document 2, balance of a direction of the edge effect is poor in a center portion in the tire width direction and in both sides in the tire width direction. Further, since the edge effect of the shallow groove is small, when the extending direction of the shallow groove is changed only in the narrow range in the tread width direction as in Patent Document 3, the effect by changing the extending direction is small.

Therefore, the present disclosure is to provide a pneumatic tire with good directional balance of an edge effect of a shallow groove.

### Means for Solving the Problem

A pneumatic tire of an embodiment includes: two center main grooves on a tire equator side and two shoulder main grooves on a grounding end side of the tire as main grooves extending in a circumferential direction of the tire; a center land portion between the two center main grooves; a mediate land portion between the center main groove and the shoulder main groove; a shoulder land portion between the shoulder main groove and the grounding end portion; and shallow grooves on a surface of each of the land portions, in which the shallow grooves in the center land portion and the shoulder land portion have many components in a circumferential direction of the tire, and the shallow grooves in the mediate land portion have more components in a tire width direction than the shallow grooves in the center land portion and the shoulder land portion.

### Advantage of the Invention

The pneumatic tire of the embodiment has excellent directional balance of an edge effect of the shallow grooves because of the above features.

### BRIEF DESCRIPTION OF THE DRAWINGS

FIG. 1 A cross-sectional view in the width direction of a pneumatic tire of an embodiment.

FIG. 2 A tread pattern (shallow grooves are omitted in the drawing) of the pneumatic tire of the embodiment.

FIG. 3 A tread pattern (shallow grooves are illustrated in the drawing) of the pneumatic tire of the embodiment.

FIG. 4 A cross-sectional view in a width direction of a shallow groove.

### BEST MODE FOR CARRYING OUT THE INVENTION

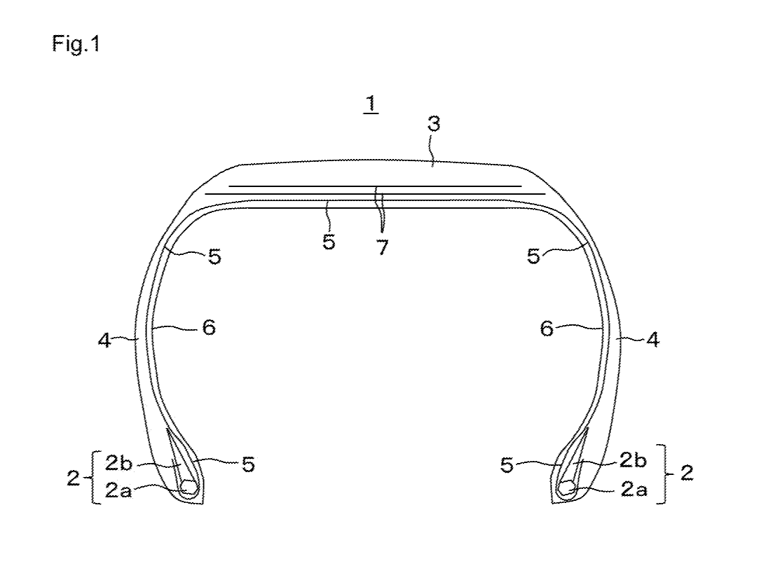

As illustrated in FIG. 1, a bead portion 2 is provided on both sides in a tire width direction of a pneumatic tire 1. The bead portion 2 is constituted by a bead core 2a made of a steel wire wound in a circular shape and a bead filler 2b made of rubber and provided on a radial outer side of the bead core 2a. A carcass ply 5 is laid across the bead portion 2 on both sides of the tire width direction. The carcass ply 5 is a sheet type member in which a plurality of ply cords arranged in a direction orthogonal to a circumferential direction of the tire are covered with rubber. The carcass ply 5 forms a frame shape of the pneumatic tire 1 between the bead portions 2 on both sides of the tire width direction, and surrounds the bead portions 2 by folding back from inside to outside in the tire width direction around the bead portions 2. A sheet type inner liner 6 made of rubber having low air permeability is adhered to the inside of the carcass ply 5.

One or a plurality of belts 7 are provided on the tire radial outer side of the carcass ply 5. The belt 7 is a member made by covering a plurality of steel-based cords with rubber. A tread rubber 3 having a grounding surface with a road surface (hereinafter, referred to as a “grounding surface”) is provided on the tire radial outer side of the belt 7. Further, a side wall rubber 4 is provided on both sides in the tire width direction of the carcass ply 5. In addition to these members, according to functional requirements of the pneumatic tire 1, members, for example, a belt lower pad or a chafer are provided.

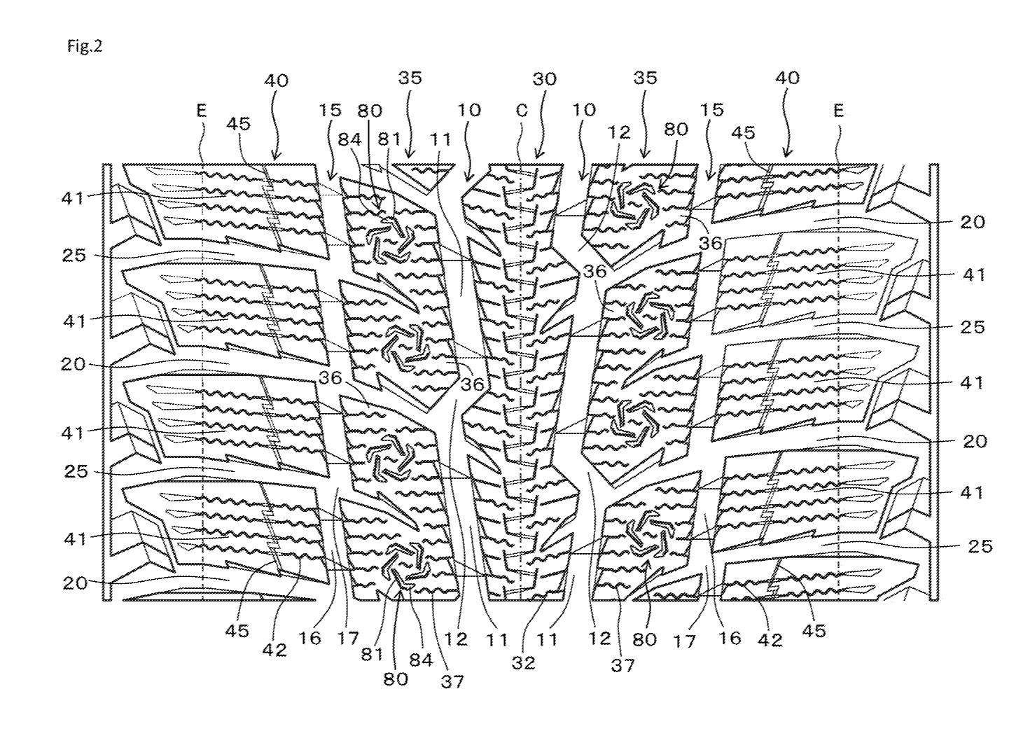

A tread pattern illustrated in FIG. 2 is formed on a surface of the tread rubber 3. In FIG. 2, the vertical direction is the circumferential direction of the tire, and the lateral direction is the tire width direction. Further, in FIG. 2, a lower side is grounded first during rolling of the tire (that is, when the vehicle is traveling). In this tread pattern, as a main groove that extends in the circumferential direction of the tire and has a wide width, a total of four main grooves, that is, two center main grooves 10 on a tire equator C side (center side in the tire width direction) and two shoulder main grooves 15 on a tire grounding end E side (outside in the tire width direction) are formed. Then, a center land portion 30 between the two center main grooves 10, a mediate land portion 35 between the center main groove 10 and the shoulder main groove 15, and a shoulder land portion 40 between the shoulder main groove 15 and the tire grounding end E are provided.

Here, the land portion is a portion formed by being partitioned by grooves. Further, the tire grounding end E is an end portion of the grounding surface in the tire width direction in a loaded state. The loaded state is a state where the pneumatic tire is rim-assembled into a normal rim to be a normal inner pressure and loaded by a normal load. Here, the normal rim is a standard rim defined by standards such as JATMA, TRA, and ETRTO. Further, the normal load is a maximum load defined in the above standards. Further, the normal inner pressure is an inner pressure corresponding to the maximum load.

The center main groove 10 includes long first groove portions 11 that extend obliquely with respect to the circumferential direction of the tire, and short second groove portions 12 that are inclined with respect to the circumferential direction of the tire and extend in a direction different from that of the first groove portion 11. Then, a first groove portion 11 and a second groove portion 12 are arranged alternately, and thus, the center main groove 10 is formed in a zigzag shape. As can be seen from the drawing, the first groove portion 11 is inclined such that a portion to be grounded later (in other words, a rear side in the rolling direction) heads toward the tire grounding end E side.

The shoulder main groove 15 includes long first groove portions 16 that extend obliquely with respect to the circumferential direction of the tire, and short second groove portions 17 that are inclined with respect to the circumferential direction of the tire and extend in a direction different from that of the first groove portion 16. Then, the first groove portions 16 and the second groove portions 17 are arranged alternately, and thus, the shoulder main groove 15 has a zigzag shape. As can be seen from FIG. 2, the first groove portion 16 is inclined such that a portion to be grounded later heads toward the tire grounding end E side.

Further, as lateral grooves that extend in the tire width direction, first lateral grooves 20 and second lateral grooves 25 are formed. The first lateral groove 20 traverses the shoulder land portion 40 and the mediate land portion 35, and extends to the center land portion 30 and is closed in the center land portion 30. Further, the second lateral groove 25 traverses the shoulder land portion 40, and extends to the mediate land portion 35 and is closed in the mediate land portion 35. Such first lateral grooves 20 and second lateral grooves 25 are alternately arranged in the circumferential direction of the tire. The second groove portion 17 of the shoulder main groove 15 overlaps with the first lateral groove 20 and the second lateral groove 25.

With the configuration of the groove as described above, the center land portion 30 between the two center main grooves 10 is configured as a rib extending in the circumferential direction of the tire without being divided by lateral grooves. Further, the mediate land portion 35 is divided by the first lateral groove 20, and thus, is a row of a plurality of mediate blocks 36 arranged in the circumferential direction of the tire. Further, the shoulder land portion 40 is divided by the first lateral groove 20 and the second lateral groove 25, and thus, is a row of a plurality of shoulder blocks 41 arranged in the circumferential direction of the tire.

Annular sipes 80 are provided in the mediate block 36. An annular sipe 80 is formed by annularly arranging a plurality of (e.g., five as illustrated in the drawing) independent small sipes 81. A small sipe 81 is a narrow groove having a narrow width where the opening end to the grounding surface is closed in the loaded state. The small sipe 81 extends in a circumferential direction of the annular sipe 80. Further, the small sipe 81 is bent toward an inner side of the annular sipe 80.

A dimple 84 is provided along the small sipe 81 on the inner side of the bent portion of the small sipe 81. The dimple 84 is a recessed portion with respect to a grounding surface. A depth of the dimple 84 is shallower than that of the adjacent small sipe 81, and for example, is 40% or less of a depth of the small sipe 81.

Further, a sipe 45 extending in the circumferential direction of the tire is provided in the shoulder land portion 40. The sipe 45 is a narrow groove having a narrow width where the opening end to the grounding surface is closed in the loaded state. The sipe 45 is inclined such that a portion to be grounded later heads toward the tire grounding end E side.

Further, the center land portion 30, the mediate block 36, and the shoulder block 41 are provided with a plurality of tire width direction sipes 32, 37, and 42 extending in the tire width direction, respectively.

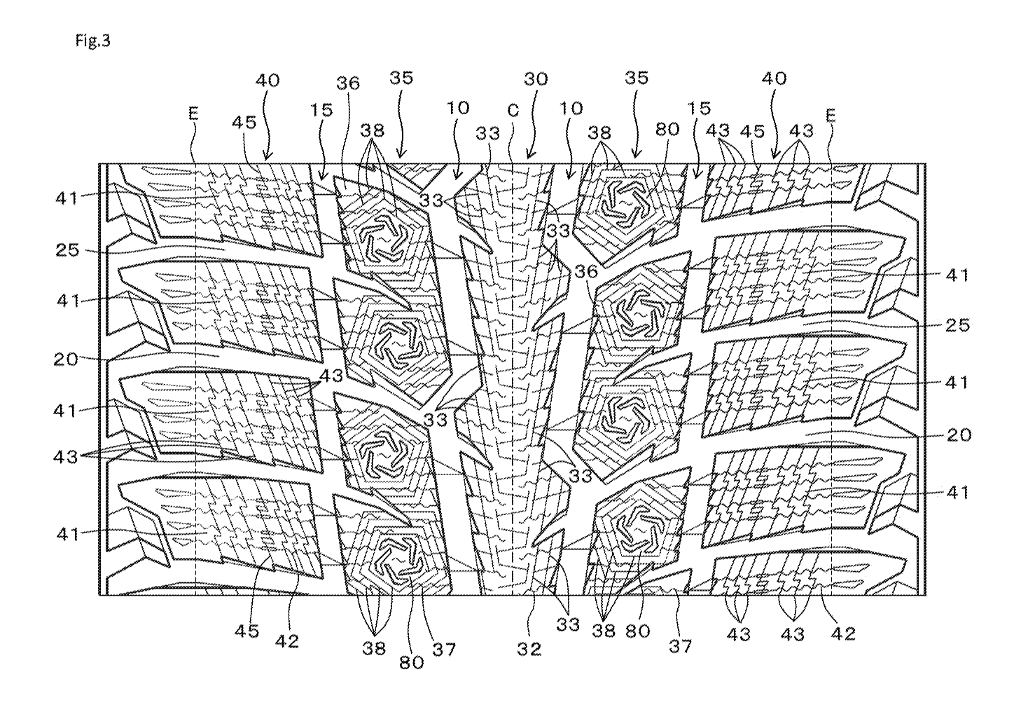

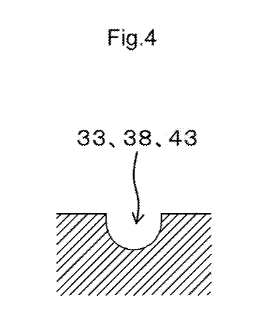

As illustrated in FIG. 3, shallow grooves 33, 38, and 43 are provided in the center land portion 30, the mediate block 36, and the shoulder block 41, respectively. FIG. 4 illustrates a cross-sectional view of the shallow grooves 33, 38, and 43. A depth of these shallow grooves 33, 38, and 43 is, for example, 0.2 to 0.4 mm (including 0.2 mm and 0.4 mm). Further, a width of these shallow grooves 33, 38, and 43 is, for example, 0.4 to 0.6 mm (including 0.4 mm and 0.6 mm).

The shallow grooves 33 in the center land portion 30 and the shallow grooves 43 in the shoulder block 41 have many components in the circumferential direction of the tire. In other words, the shallow grooves 33 in the center land portion 30 and the shallow grooves 43 in the shoulder block 41 extend toward the circumferential direction of the tire rather than the tire width direction. Meanwhile, the shallow grooves 38 in the mediate block 36 have more components in a tire width direction than the shallow grooves 33 in the center land portion 30 and the shallow grooves 43 in the shoulder block 41.

Taking a look into the shallow grooves 33 in the center land portion 30 and the shallow grooves 43 in the shoulder block 41, these shallow grooves 33 and 43 are inclined such that a portion that is grounded later during rolling of the tire heads toward the tire grounding end E side. Further, the shallow grooves 33 in the center land portion 30 are straight, whereas the shallow grooves 43 in the shoulder block 41 have a zigzag shape. Further, the shallow grooves 43 in the shoulder block 41 are arranged more densely than the shallow grooves 33 in the center land portion 30. The density of the shallow grooves is calculated by dividing the total area of the shallow grooves in the land portion or in the block in a plan view (that is, when viewed from the tire outer radial side) by the area of the land portion or the area of the block.

Further, the shallow grooves 38 in the mediate block 36 illustrated are annular (closed loop) in a plan view. Therefore, it is not able to define whether the shallow grooves 38 extend in the circumferential direction of the tire or in the tire width direction. Therefore, as compared with the shallow grooves 33 in the center land portion 30 and the shallow grooves 43 in the shoulder block 41, the shallow grooves 38 may be defined to have many components in the tire width direction. As illustrated in FIG. 3, one annular sipe 80 is surrounded by a plurality of shallow grooves 38 having different sizes of closed loops. The shallow grooves 38 in the mediate block 36 is a pentagon in a plan view, but may be another polygon or circle in a plan view. A portion that is interrupted at the end portion of the mediate block 36 may be regarded as a part of the annular shallow grooves 38.

As illustrated in drawings, these shallow grooves 33, 38, and 43 may intersect with the tire width direction sipes 32, 37, and 42. Of course, the shallow grooves 33, 38, and 43 are shallower than the tire width direction sipes 32, 37, and 42.

As described above, in the pneumatic tire 1 of the embodiment, the shallow grooves 33 in the center land portion 30 and the shallow grooves 43 in the shoulder block 41 have many components in the circumferential direction of the tire, and the shallow grooves 38 in the mediate block 36 have more components in the tire width direction than the shallow grooves 33 and 43. Therefore, taking a look into the whole tread, the directional balance of the edge effect of the shallow grooves 33, 38, and 43 are excellent.

Further, although the shoulder land portion 40 has a shorter grounding length in the circumferential direction of the tire than the center land portion 30, the shallow grooves 43 in the shoulder block 41 are arranged more densely than the shallow grooves 33 in the center land portion 30. Therefore, the edge effect occurs sufficiently in the region of the shoulder block 41.

Further, since the shallow grooves 43 in the shoulder block 41 has a zigzag shape, as compared with a case of being straight, the shallow grooves 43 are long, and thus, the length of the edge thereof is long. Therefore, the edge effect occurs sufficiently even in the region of the shoulder block 41 having a short grounding length.

Further, since the shallow grooves 38 in the mediate block 36 are annular, the directional balance of the edge effect in the mediate block 36 is particularly excellent. Further, since the shallow grooves 38 in the mediate block 36 are annular and arranged so as to surround the annular sipe 80, the new pneumatic tire 1 is excellent in design.

The above embodiments are examples, and the scope of the present disclosure is not limited thereto. Various modifications may be made to the above embodiments within the scope without escaping from the purpose of the present disclosure. For example, instead of the annular shallow grooves, shallow grooves extending in the tire width direction may be provided in the mediate block 36.

### DESCRIPTION OF REFERENCE NUMERALS AND SIGNS

C . . tire equator, E . . . tire grounding end, 1 . . . pneumatic tire, 2 . . . bead portion, 2a . . . bead core, 2b . . . bead filler, 3 . . . tread rubber, 4 . . . side wall rubber, 5 . . . carcass ply, 6 . . . inner liner, 7 . . . belt, 10 . . . center main groove, 11 . . . first groove portion, 12 . . . second groove portion, 15 . . . shoulder main groove, 16 . . . first groove portion, 17 . . . second groove portion, 20 . . . first lateral groove, 25 . . . second lateral groove, 30 . . . center land portion, 32 . . . tire width direction sipe, 33 . . . shallow groove, 35 . . . mediate land portion, 36 . . . mediate block, 37 . . . tire width direction sipe, 38 . . . shallow groove, 40 . . . shoulder land portion, 41 . . . shoulder block, 42 . . . tire width direction sipe, 43 . . . shallow sipe 43, 45 . . . sipe, 80 . . . annular sipe, 81 . . . small sipe, 84 . . . dimple

1. A pneumatic tire comprising: two center main grooves on a tire equator side and two shoulder main grooves on a grounding end side of the tire as main grooves extending in a circumferential direction of the tire; a center land portion between the two center main grooves; a mediate land portion between the center main groove and the shoulder main groove; a shoulder land portion between the shoulder main groove and the grounding end portion; and shallow grooves on a surface of each of the land portions,
wherein the shallow grooves in the center land portion and the shoulder land portion have many components in a circumferential direction of the tire, and the shallow grooves in the mediate land portion have more components in a tire width direction than the shallow grooves in the center land portion and the shoulder land portion.

2. The pneumatic tire according to claim 1, wherein the shallow grooves in the mediate land portion have an annular shape.

3. The pneumatic tire according to claim 1, wherein the shallow grooves in the shoulder land portion are arranged more densely than the shallow grooves in the center land portion.

4. The pneumatic tire according to claim 1, wherein the shallow grooves in the shoulder land portion have a zigzag shape.
